(19) United States
(12) Patent Application Publication
(10) Pub. No.: US 2024/0345645 A1
(43) Pub. Date: Oct. 17, 2024

(54) Electronic Assembly, Apparatus and Method for Detecting User's Fingerprints

(71) Applicant: Telefonaktiebolaget LM Ericsson (publ), Stockholm (SE)

(72) Inventors: Alexander Hunt, Tygelsjö (SE); Mohammed Zourob, London (CA); Andreas Kristensson, Södra Sandby (SE)

(21) Appl. No.: 18/701,091

(22) PCT Filed: Oct. 14, 2021
(86) PCT No.: PCT/EP2021/078437

§ 371 Date: Apr. 12, 2024

(51) Int. Cl. G06F 1/3231; G06F 1/3234; G06F 3/04883; G06F 21/32; G06V 40/13

(52) U.S. Cl. CPC G06F 1/3231; G06F 1/3262; G06F 3/04883; G06F 21/32; G06V 40/1306; G06F 2203/04108

(57) ABSTRACT

Electronic assembly and method (100) for detecting user's fingerprints, comprising a touch-sensitive surface (110) configured to register user touch; a fingerprint sensor (120) for detecting user's fingerprints on at least a part of the touch-sensitive surface; a first controller circuit (CU1) configured to activate the fingerprint sensor and receive fingerprint information from the fingerprint sensor and a second controller circuit (CU2) configured to detect the position and/or movement of a user's finger on (154) or above (152) the touch-sensitive surface in response to signals from the touch-sensitive surface. The electronic assembly further comprises a host system (CPU) connected to the first and second controller circuits, where the host system comprises circuitry for processing information received from the first and second controller circuits. The first controller circuit configured to receive information from the second controller circuit related to the current position (142, 152) and/or movement (v) of the user's finger on or above the touch-sensitive surface and activate a portion (165) of the fingerprint sensor on which to perform fingerprint reading.

### TECHNICAL FIELD

The present application relates to an electronic assembly for detecting user's fingerprints on a touch sensitive surface. Moreover, it relates to an apparatus comprising the electronic assembly and a method for detecting user's fingerprints on a touch sensitive surface. Furthermore, the present application also relates to a computer program product comprising computer program code and a computer-readable medium storing the computer program product for performing the method for detecting user's fingerprints.

### BACKGROUND

User fingerprint detection has been around for a number of years. It has become commonplace in smartphones, tablets and computers among others. Usually, it is implemented as an area either outside of the device's touchscreen or near the key board, where it is either exclusively reserved for fingerprint scanning or used as a physical or virtual button. Also, fingerprint scanning has been made available almost universally in premises requiring user identification, such as border controls, police offices and so on. In some instances, in order to be able to identify a user via his or her fingerprints, an identification procedure is necessary, where the user is required to touch the areas reserved for fingerprint scanning with the same finger multiple times under different angles. For each new position of the user's finger during the identification procedure, a new fingerprint scan is performed and stored as a fingerprint template. These fingerprint templates increase the accuracy of a later fingerprint scan, where the later fingerprint scan is compared to the stored fingerprint template of the specific user.

In recent years, fingerprint sensors have also, in some cases, been placed underneath the touchscreen of some devices in order to be able to provide a larger display and touchscreen area, while still incorporating the fingerprint function. Examples of such devices are smartphones and tablets.

Recently, ideas have emerged where the size of the fingerprint sensor is almost or as large as the touchscreen of the device. Such an implementation is outlined in the patent application no. US20150036065A1. While this idea offers the advantage of being able to perform fingerprint scanning on any part of the touchscreen, the downside is increased power consumption compared with a standard fingerprint scanner implemented as a smaller unit underneath the touchscreen or on a separate area outside of the touchscreen.

Moreover, standard fingerprint sensor implementations usually include a host system where among other units a central processing unit (CPU) is included and where the host system has a built-in driver unit for the fingerprint sensor that controls the fingerprint sensor. This means, that the host system is involved in fingerprint scanning operations at all times, leading also to a higher power consumption.

Thus, there is a need to solve or at least alleviate some of the issues with known fingerprint solutions which are either available on the market or which have been disclosed in various patent publications.

### SUMMARY

A solution is presented in the independent claims. Preferable embodiments are listed in the dependent claims.

According to one aspect, the present solution relates to an electronic assembly for detecting a user's fingerprint. The electronic assembly comprises a touch-sensitive surface configured to register user touch. Furthermore, the electronic assembly comprises a fingerprint sensor for detecting fingerprints on at least a part of the touch-sensitive surface. Moreover, the electronic assembly comprises a first controller circuit configured to activate the fingerprint sensor and receive fingerprint information from the fingerprint sensor. Also, the electronic assembly comprises a second controller circuit configured to detect the position and/or movement of a user's finger on or above the touch-sensitive surface in response to signals from the touch-sensitive surface. In addition, the electronic assembly comprises a host system (CPU) connected to the first and second controller circuits where the host system comprises circuitry for processing information received from the first and second controller circuits. The first controller circuit is further configured to receive information from the second controller circuit related to the current position and/or movement of a user's finger on or above the touch-sensitive surface. It also is configured to activate a portion of the fingerprint sensor on which to perform fingerprint reading.

One advantage of this solution is that the first controller circuit and the second controller circuit are able to perform fingerprint reading without involving the host system. As a result, less computational resources are used in performing a fingerprint scan. This in turn has the advantage of reduced power consumption by the electronic assembly. Moreover, in cases where the area taken up by the fingerprint sensor is either as large as the touch-sensitive surface of the electronic assembly or at least much larger than the area of the user's finger to be scanned, the solution above will also result in a reduction of the power consumption of the fingerprint sensor, since only a portion of the fingerprint sensor will be activated. Especially the two advantageous features mentioned earlier, i.e. non-involvement of the host system in the calculations of the position of the user's finger and activation of a part of the fingerprint scanner where the user's finger is detected on or above the touch-sensitive surface, result together in an even lower power consumption of the electronic assembly.

In an embodiment of the present solution presented above, the first controller circuit is further configured to instruct the fingerprint sensor to perform a fingerprint reading at the portion of the fingerprint sensor corresponding to the position of the user's finger on the touch-sensitive surface received from the second controller circuit. This has the advantage that the fingerprint sensor is activated only after the user has touched the touch-sensitive surface and at the position covered by the user's finger.

In another embodiment of the present solution, the electronic assembly further comprises a processing circuit in one of the first controller circuit and the second controller circuit. In this embodiment, the processing circuit is configured to compute data related to the movement of the user's finger on or above the touch-sensitive surface from signals received from the touch-sensitive surface. Moreover, the processing circuit is further configured to compare the data related to the movement of the user's finger with a movement threshold value. This has the advantage of being able to prepare for a fingerprint scan of a user's finger at the right time and location on the touch-sensitive surface even if the user is moving the finger across the touch-sensitive surface of the electronic assembly. Also, the fingerprint scan of a user's finger may be prepared even if the user has not actually touched the touch-sensitive surface yet, but his or her finger is sufficiently close to the touch-sensitive surface that its position can be detected by the second controller circuit. As mentioned earlier, the second controller circuit is configured to detect the position and/or movement of the user's finger.

In another embodiment, the first controller circuit is configured to activate the fingerprint sensor at a position where the data related to the movement of the user's finger is equal to or below the movement threshold value. An advantage of this embodiment in addition to being able to prepare for a fingerprint scan of a moving user's finger over the surface of the touch-sensitive surface is the ability to prepare for the fingerprint scan once the user's finger moves sufficiently slowly, where sufficiently slowly is defined as being equal to or less than a movement threshold value This is also valid for the situation that the user has not actually touched the touch-sensitive surface, but where his or her finger is sufficiently close to the touch-sensitive surface that its position can be detected by the second controller circuit. By sufficiently close it is meant that the orthogonal distance of the user's finger to the touch-sensitive surface is such that that a minimum capacitance (in the case of a capacitive touch-sensitive surface) will be registered by the second controller circuit.

In yet another embodiment of the present solution, the first controller circuit is further configured to instruct the fingerprint sensor to perform a fingerprint reading at the position on the touch-sensitive surface where the data related to the movement of the user's finger is equal to or below the movement threshold value. An advantage of this is that the fingerprint scanner will already have been activated when the movement of the user's finger has reached a value equal or below the threshold value and will thus perform a quicker scan when the user has finally touched the touch-sensitive surface.

In yet another embodiment of the present solution, the data related to the movement of the user's finger on or over the touch-sensitive surface calculated by the processing circuit is generated in the form of a movement vector. This has the advantage that the processing circuit can predict when and/or where on the touch-sensitive surface to perform fingerprint scanning. The movement vector can comprise speed, acceleration, deceleration or direction of movement of the user's finger on or above the touch-sensitive surface. Also, it may comprise a combination of these values, such speed, acceleration, deceleration combined with direction of movement. Analogously, the movement threshold value may comprise speed, acceleration, deceleration or direction of movement of the user's finger on or above the touch-sensitive surface.

According to another embodiment of the present solution, the first and second controller circuits in a first mode of operation are configured to communicate with each other independently of the host system. An advantage of this embodiment is that in operational modes where the electronic assembly may not require full computational resources by the host system, such as in lock-screen modes, standby modes, battery-saving modes, and others, the electronic assembly can save power by performing user touch sensing and user finger scanning without involving the host system.

According to another embodiment, the first and second controller circuits in a second mode of operation are configured to communicate with the host system. In this second mode of operation, the host system is configured to transmit data associated with the position and/or movement of the user's finger over one or more interactive areas on the touch-sensitive surface to the processing circuit. These one or more interactive areas may be associated with expected user input via touch. This would account for the situation where the electronic assembly is in a normal mode of operation (thus not in standby mode or some other power-saving mode) where the host system is running a specific software application. An advantage of this embodiment is that the finger touch or movement over an application specific interactive area on the touch-sensitive surface can be predicted by the host system.

In another embodiment, the processing circuit is further configured to compare the data received from the host system with a movement threshold value and the position of one or more interactive areas on the touch sensitive surface. As a result of the comparison, the processing circuit may instruct the first controller circuit to activate the fingerprint sensor when movement of the user's finger is below the movement threshold value and within the one or more interactive areas. This has the advantage that the fingerprint sensor can be prepared for fingerprint scanning when the user has moved or is moving his or her finger to areas that are interactive for the application that the host system is currently running.

According to another embodiment, the processing circuit is configured to instruct the first controller circuit to let the fingerprint scanner perform a fingerprint scan when movement of the user's finger is below the movement threshold value, within the one or more interactive areas and when the movement of the user's finger is on the touch-sensitive surface. Thus, when the user finally touches and/or moves over the one or more interactive areas on the touch-sensitive surface the fingerprint scanner will be already active and perform the fingerprint scan faster.

In one embodiment, the fingerprint sensor may be located behind the touch-sensitive surface and have a size that covers at least a portion of the touch-sensitive surface. This has the advantage that fingerprint scanning can be performed over a much larger surface instead of one specific area.

Also, the fingerprint sensor may be located behind the touch-sensitive surface and have a size that covers the entire touch-sensitive surface.

In another embodiment, the electronic assembly may further comprise a memory which is configured to store information related to the movement of the user's finger on or over the touch-sensitive surface and/or fingerprints registered by the fingerprint sensor. This memory may located in a secure area of the host system in order to safely store user specific finger movement and fingerprint information.

In another embodiment, the touch-sensitive surface of the electronic assembly may be a touchscreen.

According to another aspect of the present solution, the solution is related to an electronic apparatus comprising the electronic assembly and its various embodiment mentioned earlier, where the electronic apparatus further comprises a display for displaying a Graphical User Interface aimed at user interaction with the electronic device and wherein the display is located behind the touch-sensitive surface of the electronic assembly and the fingerprint sensor of the electronic device.

In another embodiment of the electronic apparatus, the display may be located in front of the touch-sensitive surface of the electronic assembly instead of behind it.

In an embodiment of the electronic apparatus, the electronic apparatus is a communication apparatus.

In another embodiment, the communication apparatus is one of a wireless communication apparatus for a cellular communication system, a tablet computer, a laptop computer, and a touch-screen terminal.

According to yet another aspect of the present solution, the solution is related to a method for detecting user's fingerprints on a touch-sensitive surface. The method comprises receiving information related to the current position and/or movement of the user's finger on or above the touch-sensitive surface in a second controller circuit. Furthermore, the method comprises activating a portion of a fingerprint sensor on which to perform fingerprint reading by a first controller circuit. Moreover, the method comprises performing fingerprint reading on the portion of the fingerprint sensor corresponding to the position of the user's finger and/or where the movement of the user's finger is below a movement threshold value on the touch-sensitive surface. Activation of the fingerprint sensor and fingerprint reading is done independently of a host system communicating with the first and second controller circuits. According to yet another aspect of the present solution, the solution is related to a computer program product comprising computer program code for performing the method mentioned above, when the computer program code is executed by a programmable processing circuit of the electronic apparatus mentioned earlier.

According to yet another aspect of the present solution, the solution is related to a computer readable medium storing a computer program product comprising computer program code for performing the method mentioned earlier when the computer program code is executed by a programmable processing circuit of the electronic apparatus mentioned earlier.

### BRIEF DESCRIPTION OF THE DRAWINGS

FIG. 1 displays a first embodiment of the electronic assembly according to the present solution.

FIG. 2A displays the first embodiment of the electronic assembly in a first situation.

FIG. 2B displays the first embodiment of the electronic assembly in a second situation.

FIG. 2C displays the first embodiment of the electronic assembly in a third situation.

FIG. 3 displays a second embodiment of the electronic assembly according to the present solution.

FIG. 4 displays a third embodiment of the electronic assembly according to the present solution.

FIG. 5 displays a first embodiment of a method according to the present solution.

### DETAILED DESCRIPTION

Before continuing with a detailed description of exemplary embodiments of the present solution, some terms and expressions will be clarified.

The term “electronic assembly” used in the description and the claims should be understood to mean any assembly of electronic components communicating with each other irrespective whether they are integrated into a single unit or as separate electronic units.

The term “comprising” used in the description and the claims should be understood to mean including the features or method steps mentioned thereafter, but not excluding the presence of other features, components and/or method steps.

In the following, several embodiments of the present solution are described keeping in mind that these embodiments are for illustration purposes only and should not be interpreted as limiting the present solution to exclusively these embodiments. After having studied the following embodiments, the skilled person may be capable of carrying out other possible embodiments within the scope of the accompanying patent claims.

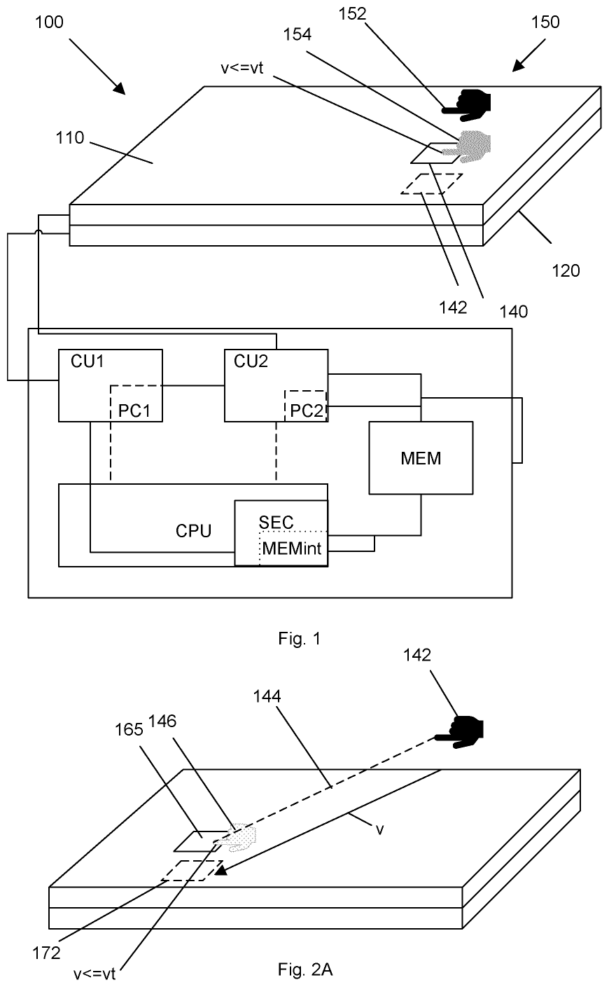

FIG. 1 depicts an electronic assembly 100 comprising a touch-sensitive surface 110, which may for example be a touchscreen module comprising a display based on OLED, AMOLED, LCD, LED, TFT or other technology. The electronic assembly comprises a touch-sensitive part registering a single or multiple touches via surface capacitance, projected capacitance, SAW (Surface Acoustic Wave), infrared light, ultrasonic sensing or other principles. For the sake of illustrating the embodiment depicted in FIG. 1 more clearly, we assume that a user is only using one finger on or above the touch-sensitive surface 110. This does not exclude the fact that the idea works equally well if the user uses multiple fingers at the same time. In another variant, the electronic assembly 100 may just comprise a touchscreen module using technology mentioned earlier, the display being separate and not forming part of the electronic assembly 100

Now, the touch-sensitive surface 110 is electrically connected to a second controller circuit CU2 whose task is to receive data on the position of one or more user's fingers 150 on or above the touch-sensitive surface (152, 154). It should be mentioned here that by the expression “position” it is meant the location of the area taken up by a user's finger on or above the touch-sensitive surface 110. Most of the touch-screen technologies used in present day electronic devices or known to the skilled person with the exception of surface acoustic wave-based, resistive touchscreens and touchscreens using ultrasonic touch sensing technology are not only able to register the position or area taken up by one a user's finger directly on the surface of the touchscreen module, but also slightly above the same surface. Using one of these technologies, the touch-sensitive surface 110 in the embodiment in FIG. 1 is also able to register the presence of a user's finger above the touch-sensitive surface 110. Furthermore, the second controller circuit CU2 is not only able to receive data on the position of the user's finger, but also to register movement of the user's finger on or above the touch-sensitive surface 110 in the form of velocity, acceleration, deceleration or direction of movement, which is calculated by the second processing circuit PC2 from the position data of the user's finger on or above the touch-sensitive surface 110.

Moreover, the second controller circuit CU2 is also connected to a memory MEM where the data on the position and/or movement of the user's finger on or above the touch-sensitive surface 110 is registered. This data on the movement of the user's finger may be registered and stored in the memory MEM in the form of a movement vector v whose elements may comprise a number of entries related to past movement values and the current movement value.

As mentioned earlier, some examples of the movement of the user's finger may be its velocity, acceleration, or deceleration or direction of movement on or over the touch-sensitive surface 110.

The memory MEM itself may be any type of internal or external memory known to the skilled person, such as a RAM (Random Access Memory), DRAM (Dynamic Random Access Memory), SRAM (Static Random Access Memory), memory card, USB (Universal Serial Bus)-memory, CD (Compact Disc)-based media or the like.

Furthermore, and depending on the mode of operation of the electronic assembly 100, the second controller circuit CU2 may or may not directly communicate with a host system CPU which itself is tasked with running various applications visible on a display of a device incorporating the electronic assembly 100. Moreover, the host system CPU may also comprise an internal memory MEMint which is located in a secure area SEC of the host system CPU. The internal memory MEMint is tasked with storing user fingerprints, while the secure area SEC is able to communicate with the first controller unit CU1 in a secure way. The user fingerprints in the internal memory MEMint are used as reference fingerprints against which fingerprints scanned by the first controller unit CU1 are compared in order to identify whether the scanned fingerprint belongs to a known user or not. These reference fingerprints may also be periodically updated. One reason for storing the reference fingerprints in the secure area SEC of the host system CPU is that the security of a device using the electronic assembly 100 cannot be easily compromised.

In the embodiment in FIG. 1, a fingerprint sensor 120 is located underneath the touch-sensitive surface 110. However, while the embodiment in FIG. 1 focuses on this particular configuration, it may equally be possible to have the fingerprint sensor integrated into the same layer as the touch-sensitive surface 110. The fingerprint sensor 120 may have a size matching the size of the touch-sensitive surface 110 located on top of it or it may be smaller, depending on the specific design chosen. Also, the fingerprint sensor 120 may be distributed across different locations underneath the touch-sensitive surface 110 or be integrated into different location on the touch-sensitive surface. Moreover, the fingerprint sensor 120 may be of any type known to the skilled person, such as capacitive, thermosensitive, image sensor or of some other known type.

In most cases the electronic assembly may be positioned in front of a display, which is the standard configuration in an electronic device today. In other configurations, such as in resistive touch-screens and touch-screens based on ultrasound technology, the touch-sensitive surface 110 may be located behind the display, while the fingerprint sensor may be located in front of the display.

The main task of the fingerprint sensor is to perform a scan of the user's finger 150 when it has touched 154 the touch-sensitive surface 110 and when its movement on the touch-sensitive surface has reached or is under a certain movement threshold value vt. This movement threshold value vt may be related to the threshold velocity, acceleration, or deceleration of the user's finger on the touch-sensitive surface 110 and is denoted by the square 140 in FIG. 1.

The fingerprint sensor 120 is in electrical contact with the first controller circuit CU1 which receives data on the shape of the user's finger 154 pressing on the touch-sensitive surface 110 and data on the position and/or movement of the user's finger 154 on or above the touch-sensitive surface 110. Already when the user's finger 152 is at an orthogonal distance above the touch-sensitive surface 110 where the second controller circuit CU2 is able to receive a signal, the first controller circuit CU1 may already activate the fingerprint sensor 120 at the appropriate position in order to prepare for fingerprint scanning. The appropriate position on the fingerprint sensor 120 for a user's finger hovering above the touch-sensitive surface 110 may be either orthogonally below the orthogonal projection of the user's finger 152 onto the touch-sensitive surface 110, i.e. at the position 142 or it may be orthogonally below a predicted final position of the user's finger 154 on the touch-sensitive surface 110. The appropriate position may be calculated either in the first processing circuit PC1 located in the first controller circuit CU1 or in the second processing circuit PC2 located in the second controller circuit CU2. Also, the processing circuit PC1, PC2 may be distributed over the first and second controller circuits CU1. CU2. The predicted final position may be calculated from a movement vector of the user's finger and a comparison to a movement threshold value vt. Aside from these components, the host system CPU mentioned earlier has the task of controlling the function of the touch-sensitive surface 110 and the fingerprint sensor 120 via the second and first controller circuits CU2 and CU1 in certain modes of operation of the electronic assembly which are different from, for example, locks-screen, standby, or battery-saving modes. Such different modes may be normal power mode, performance mode, balanced mode, or some other non-power saving mode in which the second and first controller circuits CU2 and CU1 communicate directly with the host system CPU and share the data obtained from the touch-sensitive surface 110 and the fingerprint sensor 120. In these different modes, the host system CPU may execute one or more applications which require user interaction, and which have one or more interactive areas on the touch-sensitive surface 110 requiring user interaction. This will be explained further down in the description.

Now, returning to the situation when the fingerprint sensor is activated, we identified two exemplary cases. In the first case, the fingerprint sensor 120 will be activated orthogonally below the present position of the user's finger 152 depicted in FIG. 1, which is relatively rare, since the user seldom lowers the finger precisely orthogonally down to the touch-sensitive surface 110 from the current position. In the second case, i.e. the user moving his finger 152 from a position above the touch-sensitive surface 110 to a different position on the touch-sensitive surface 110 is much more common.

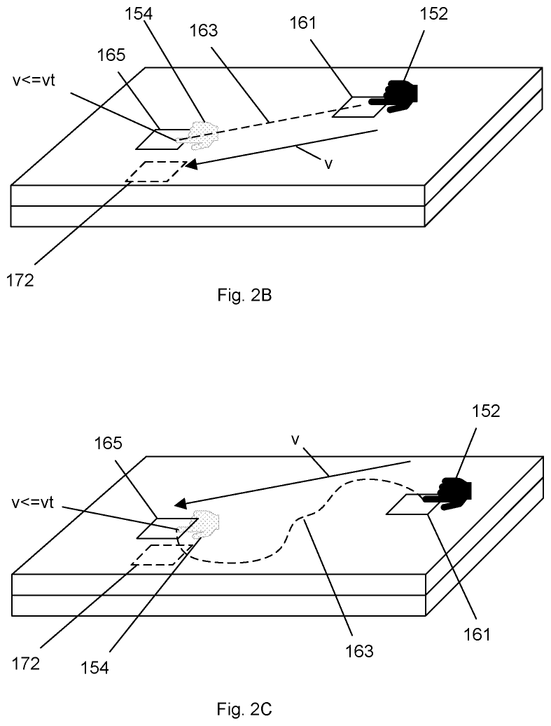

This case is illustrated in FIG. 2A. Here, the user's finger is at an initial position 142 above the touch-sensitive surface 110 and moves his or her finger towards the touch-sensitive surface 110 along the line 144 at a rate depicted by a movement vector v towards the position 146 which corresponds to the area 165 on the touch-sensitive surface. If at position 165, the first processing circuit PC1 from the movement data received from the second control unit CU2 detects that the movement of user's finger is equal to or lower than a movement threshold value vt, the first controller circuit CU1 will activate the fingerprint sensor 120 and instruct it to perform a fingerprint scan at the position 172 corresponding to the position 165 on touch-sensitive surface 110 where the movement of the user's finger is equal to or below the movement threshold value vt.

As mentioned earlier, the movement of the user's finger on or above the touch-sensitive surface may be saved in the form of a movement vector whose elements may for example be velocity, acceleration, or deceleration of the user's finger. Likewise, the movement threshold value vt may be one of velocity, acceleration or deceleration of the user's finger on the touch-sensitive surface.

FIGS. 2B and 2C depict scenarios where the user's finger is present on the touch-sensitive surface 110 and is moving on the surface from an initial position to an end position or towards a position where it has either reached or is below the movement threshold value vt. In FIG. 2B, the user's finger is located at an initial position 152 covering an area 161 on the touch-sensitive surface 110. The user then proceeds to move the finger along the straight line 163 towards a position 154 occupying an area 165 which may be either an end position or a position at which the movement v of the user's finger is either equal to or less than the movement threshold value vt. The first processing circuit PC1 or the second processing circuit PC2 may already predict at which position on the touch-sensitive surface the user's finger will be equal to or below the movement threshold value vt by checking the movement values of the user's finger received from the second controller CU2 and stored in a movement vector v. In this way the controller circuit CU1 may already in advance activate the fingerprint sensor 120 at the position 172 in order to speed up the fingerprint scan. Otherwise, the first controller circuit CU1 may wait with the fingerprint sensor activation until the movement threshold value is reached or undercut.

FIG. 2C illustrates the situation where the user's finger moves from an initial position 152 along an irregular trajectory 163 from a starting area 161 on the touch-sensitive surface 110 to an end position 154 taking up an area 165 on the touch-sensitive surface 110. The movement is registered in a movement vector v, which elements as in the previous cases may comprise the movement velocity, acceleration, or deceleration of the user's finger on the touch sensitive surface 110. Once the second controller unit CU2 with the help of the calculations performed by the second processing circuit PC2 detects that the movement of the user's finger on the touch sensitive surface 110 has reached a movement threshold value vt or gone below vt (i.e. v<=vt), it may send the position of the user's finger where this has occurred to the first controller circuit CU1 which, in turn, instructs the fingerprint scanner 120 to start scanning the user's finger at the corresponding position 172 on the fingerprint scanner 120. When the second processing circuit PC2 through monitoring the movement of the user's finger in the movement vector detects that the trajectory is somewhat irregular, it may be difficult to predict where on the touch-sensitive surface 110 the movement of the user's finger will fulfil the criterion v<=vt, so it may be difficult for the first controller circuit CU1 to activate the fingerprint sensor 120 in advance compared to previous cases where the movement is more linear. It should be mentioned that the tracking of the movement of the user's finger may be done either in the first processing circuit PC1 or in the second processing circuit PC2, as desired. If done in the first processing circuit PC1, no data on where the movement threshold criterion v<=vt is met need to be sent from the second controller circuit CU2 to the first controller circuit CU1.

In any of the aforementioned cases shown in FIGS. 1, 2A-2C the second controller circuit CU2 and the first controller circuit CU1 may exchange data on the movement of the user's finger and activate and instruct the fingerprint sensor 120 to activate the fingerprint scanner at a position where the v<=vt condition is fulfilled without the involvement of the host system CPU. This has the advantage of using less computational resources and therefore saving battery power. Usually, and according to what was stated in FIG. 1, this will be the case when the electronic assembly is in a lock-screen, power saving, standby, or some other power conservation mode. In other cases, and especially in those where the host system CPU is actively running one or more applications, the host system CPU will be involved as well and basically controlling the operation of the first and second controller circuits CU1, CU2 and the respective function of the touch-sensitive surface 110 and the fingerprint scanner 120.

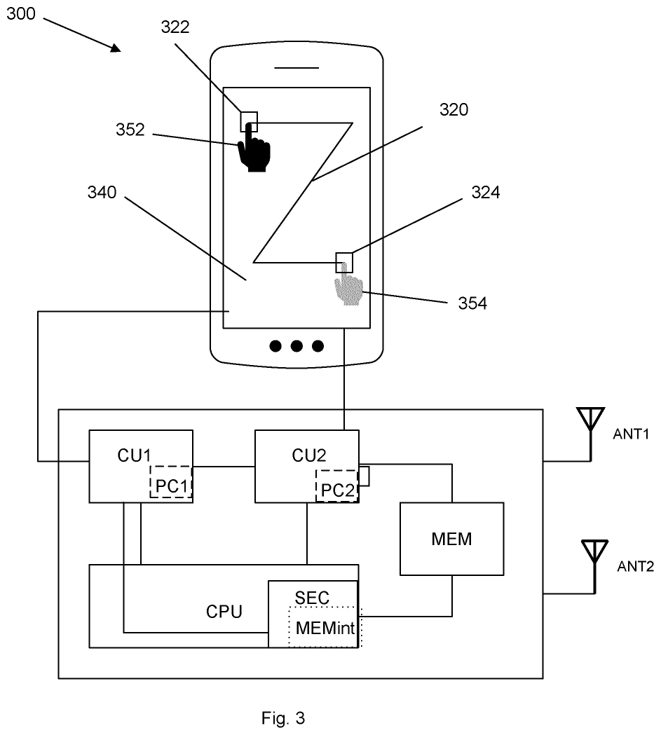

FIG. 3 illustrates a communication device 300 incorporating the electronic assembly 100 from FIG. 1. Besides the electronic assembly 100 itself and its aforementioned components, the communication device further comprises a receiver ANT1 and a transmitter ANT2 for receiving and transmitting communication signals from other communication devices. The receiver and transmitter may be integrated into a single component and also be capable of wireless communication including communication in mobile communication networks with other communication devices and/or base station transceivers (not shown). They may be capable of MIMO transmission in the wireless network according to IEEE 802.11 ax, 802.11ac, 802.11b/g/n or any other wireless standard. Moreover, the communication device 300 via its receivers and transmitters ANT1, ANT2 may be capable of communication in a mobile communication network according to known 2G, 3G, 4G or 5G standards.

As stated in the embodiment in FIG. 1, the communication device 300 may have a memory MEM located outside the host system CPU or inside the host system CPU shown as the dotted rectangle inside the host system CPU. Also, in another variant, a part of the memory storing user's fingerprints which are later compared to the fingerprints scanned by the fingerprint scanner 120 from FIG. 1 may be located in the host system CPU for security reasons. The remaining part of the memory MEM storing the movement vector where the movement of the user's finger on or over the touch-sensitive surface 110 is located, may be inside the host system CPU or outside of the host system CPU as shown in FIG. 3

The communication device 300 incorporating the electronic assembly 100 mentioned earlier may be a smartphone, tablet, phablet (combination of smartphone and tablet), a smartwatch or any other device having touchscreen technology and fingerprint reading technology incorporated in the electronic assembly 100.

Analogous to FIG. 1, the second controller circuit CU2 is electrically connected to the touch-sensitive area 340 receiving signals from it whenever the user's finger 354 is located above or on the touch-sensitive area 320. Also, the second controller circuit CU2 is in communication with the first controller circuit CU1 to transmit data received from the touch-sensitive area 320) further to the first controller circuit CU1. Based on this data received from the second controller circuit CU2, the first controller circuit CU1, which is in electrical contact with a fingerprint sensor (not shown) instructs the fingerprint sensor to start scanning the user's finger when it has touched the surface of the touch-sensitive area 320 or when the movement of the user's finger is below a movement threshold value on the touch-sensitive areas 320. The first controller circuit CU1, as in FIG. 1, may also activate the fingerprint sensor at a predicted location to prepare for a fingerprint scan if it detects from the data received from the 20) second controller circuit CU2 that the user's finger 354 is approaching the touch-sensitive surface 320 and has a reached a movement threshold value or undercut it when it finally touches the touch-sensitive surface 320. This has been described previously in more detail in FIG. 1 and the previous figures.

In FIG. 3, a typical scenario for an electronic device, such as the electronic device 300 is illustrated where the user uses his or her finger to “open” the electronic device 300 from a lock-screen or a power-saving mode into a normal operation mode. The user may do so by drawing a predefined pattern on the touch-sensitive surface 320, which in this example is illustrated in the shape of the letter “Z” of the alphabet. The user may touch the touch-sensitive area 320 at the position 324 with the finger and draw the “Z” shape over the screen until the final position 322. During the movement of the user's finger from the initial position 324 until the end position 322 the second controller circuit CU2 may deliver data from the touch-sensitive area 320 either directly to the first controller circuit CU1 or convert them into a movement vector as described earlier before transmitting them the first controller circuit CU1 which then may use the data to calculate whether or not the movement of the user's finger 354 from the initial position 324 until the user's finger 352 at the final position 322 on the touch-sensitive surface has reached the movement threshold value or gone below it. At any point on the “Z” trajectory described by the finger, the first controller circuit CU1 may instruct the fingerprint scanner to start a fingerprint scanner and scan the user's finger where the movement threshold criterion has been met. This may be done entirely by the first controller circuit CU1 without involvement of the host system CPU, which will save computational and thus battery power.

In another scenario, the “Z”-shape instead being used for opening the electronic device 300 from a lock-screen or standby mode, may be used a command gesture by the user. This gesture may instruct the electronic device to execute one or a series of predefined actions while the device 300 is not in standby or lock-screen mode, but in normal operation mode. In that operation mode, the first and second controller circuits CU1 and CU2 may communicate with the host system CPU which then may perform the necessary movement vector calculations and instruct the first controller circuit CU1 to order the fingerprint scanner to scan the user's fingerprint when the movement threshold criterion is fulfilled.

It should be clear to the skilled person who has read the description of FIG. 3, that any other shape than “Z” can be used to involve the second and first controller circuits CU2, CU1 in a movement vector calculation and fingerprint scanning actions once the movement threshold criterion is fulfilled, whether in lock-screen or standby mode or in normal mode.

In another variant not shown in FIG. 3, where the electronic device 300 is in a normal operation mode, the host system CPU may be running a software application requiring user interaction via one or more interactive areas shown on the display of the electronic device 300, where the one or more interactive areas are activated by a touch of the user's finger. When the second controller circuit CU2 detects the presence of the user's finger 354 on or above the touch-sensitive area 320, it records the movement data of the user's finger in a movement vector. Now the host system CPU may receive this movement data and predict from the data in the movement vector where on or above the touch-sensitive surface 320 the user's finger is likely to be equal to or less than the movement threshold value vt. If the predicted position of the user's finger where the movement threshold value vt is reached or is lower than vt and where the predicted position fall in one of the interactive areas of the application associated with these interactive areas, the host system may instruct the first controller circuit CU1 to activate the fingerprint sensor in order to prepare for a fingerprint scan. Once the user's finger has landed or reached the interactive area on the touch-sensitive surface 320, the host system CPU may then issue a command to the first controller circuit to instruct the fingerprint scanner 120 to perform a fingerprint scan.

As already mentioned in FIG. 1, the host system CPU in FIG. 3 may comprise a secure area SEC in turn comprising an internal memory MEMint which stores reference user fingerprints. The secure area SEC is in communication with the first controller unit CU1 when the scanned user fingerprint is to be compared to the stored reference user fingerprints in the internal memory MEMint in order to determine whether the scanned user fingerprint belongs to a known user or not.

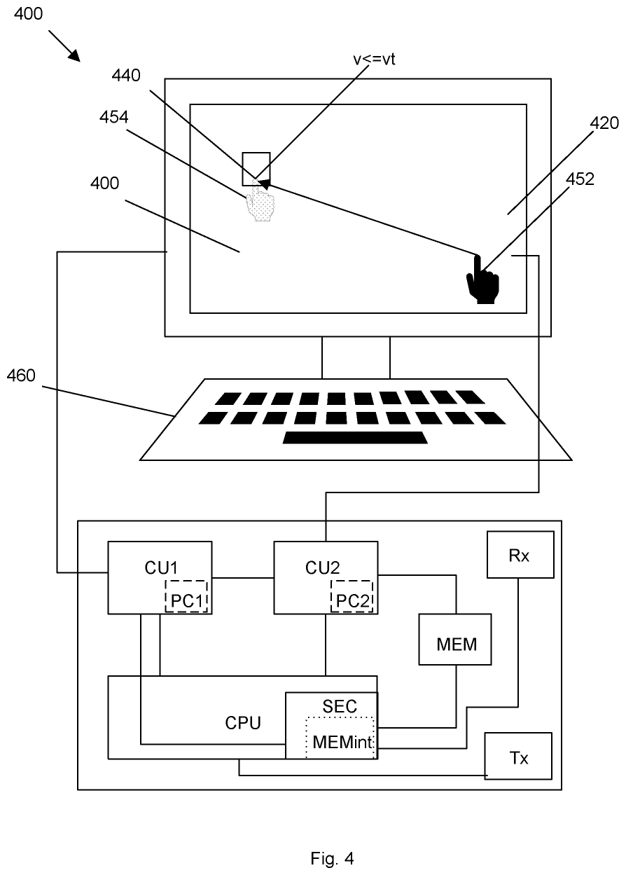

FIG. 4 illustrates another possible scenario for an electronic device implementing the electronic assembly 100 form FIG. 1, namely the electronic device 400 which is pictured in the form of a computer or a data terminal. The presence of a keyboard 460 is optional.

The operation of the electronic device 400 is analogous to the electronic device 300 mentioned earlier with the distinction that the receiver Rx and transmitter Tx may be adapted for wireline communication. Also, although depicted as separate units, the receiver Rx and transmitter Tx may be integrated into one unit and thus function as a transceiver. It is also worth mentioning that the receiver Rx and transmitter Tx may be adapted to function both in a wireline communication network and a wireless communication network of which a mobile communication network is one example.

The second controller circuit CU2, like in the case in FIG. 3, is in electrical communication with and adapted to control the operation of the touch-sensitive surface 420 and to receive data related to user touch on the touch-sensitive surface 420.

Furthermore, the second controller circuit CU2 is connected to the first controller circuit CU1 performing the same operation as in FIG. 3. Also, the function of the first controller circuit CU1 in relation to the fingerprint scanner (not shown) is the same as in FIG. 3.

In a lock-screen, standby, or other low-power mode, the second and first controller circuit CU2 and CU1 may not involve the host system CPU in the calculations necessary to decide when and where to perform fingerprint scanning of the user's finger 452. Now, the user may move his or her finger 452 from a location above the touch-sensitive surface 420 to a location 440 on the touch-sensitive surface 420. The second controller circuit CU2 will monitor the movement of the user's finger, gather movement data in a movement vector v and transfer the data to the first controller circuit CU1 When the movement threshold criterion has been met, i.e. when v<=vt then the first controller circuit CU1 will instruct the fingerprint scanner to perform a fingerprint scan on the user's finger 454 at the location 440. Like in FIG. 3, the first controller circuit CU1 may also predict the position of the user's finger 452 at which it will fulfill the movement threshold criterion and already activate the fingerprint scanner before the user's finger has reached the predicted location in order to perform faster fingerprint scanning.

In other modes of operation of the electronic device 400, such as normal, performance, balanced or any other custom mode where active applications requiring user interaction are run by the host system CPU, the CPU may perform monitoring of the movement of the user's finger 452, calculation of the movement vector, prediction of the location on the touch-sensitive surface 420 where the movement threshold will be fulfilled and activation of the fingerprint sensor for fingerprint scanning via the first controller circuit CU1 much in the same way as described earlier in the description of FIG. 3. The same goes for detection of the user's finger in one or more interactive areas associated with a software application run by the host system CPU which was already described earlier in relation to the embodiment in FIG. 3. As previously mentioned in FIG. 1, the host system CPU in FIG. 3 may comprise a secure area SEC in turn comprising an internal memory MEMint which stores reference user fingerprints. The secure area SEC is in communication with the first controller unit CU1 when the scanned user fingerprint is to be compared to the stored reference user fingerprints in the internal memory MEMint in order to determine whether the scanned user fingerprint belongs to a known user or not.

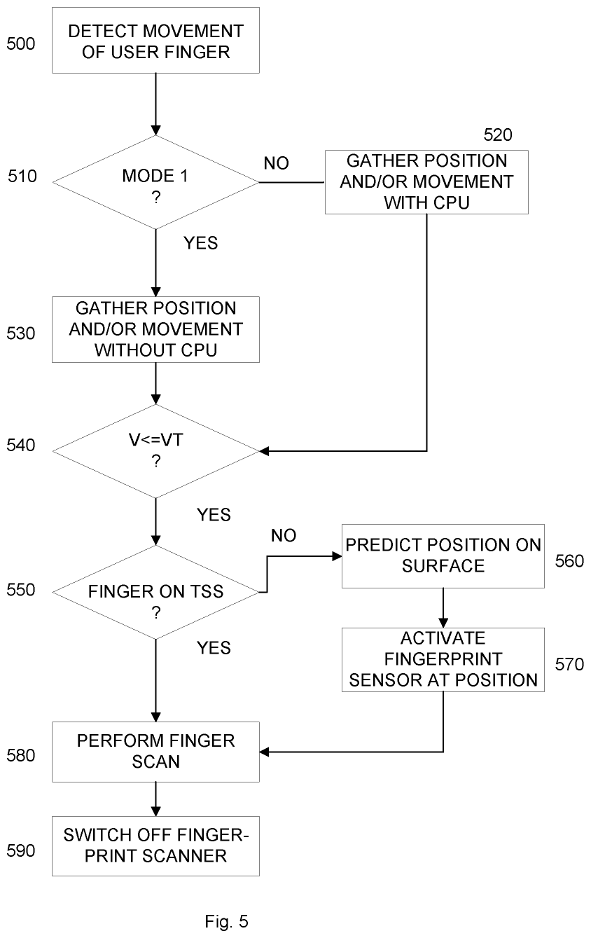

FIG. 5 depicts a method according to one embodiment of the present solution. It should be mentioned here that the method steps described below do not necessarily imply that the method according to the present solution is exclusively limited to the embodiment of FIG. 5 nor that the absence of certain method steps in FIG. 5 indicates their absence in the method according to the present solution. For the sake of clarity, it should also be emphasized that although the method steps in FIG. 5 are listed in a certain order this should not be construed as the method according to the present solution being exclusively limited to this order or these steps, since certain steps may be executed at the same time or in a different order in different embodiments.

The following description of the method in FIG. 5 is thus for illustration purposes only.

Now, at step 500, movement or even a presence of a user's finger is detected above or on a touch-sensitive surface, such as the touch-sensitive surface 110 of the electronic assembly 100 described in FIG. 1. The movement or presence is detected by a controller circuit, such as the second controller circuit CU2 which is electrically connected to the touch-sensitive surface. By using the term movement or presence above the touch-sensitive surface it is meant that the orthogonal distance between the tip of the user's finger and the touch-sensitive surface is such that a capacitance (in the case of capacitive touchscreen) or an interference of a standing wave (in the case of standing wave screens) can be detected and converted into a measurable voltage signal by the second controller circuit.

At step 510, a first controller circuit, such as the first controller circuit CU1 form FIG. 1, checks whether the electronic assembly is in first mode of operation, i.e. mode 1. Mode I can be characterized as a lock-screen, low-power, standby or some other battery-saving mode of the electronic assembly, such as the electronic assembly 100 from FIG. 1.

If this is the case, the second controller circuit at step 530 starts gathering movement data on the user's finger which may be stored in the form of a movement vector. The elements of the movement vector may register velocity, acceleration, or deceleration of the user's finger on or above the touch-sensitive surface.

If not, i.e. the electronic assembly being in mode 2, meaning in normal, balanced, performance or some other non-battery saving mode, the gathering of the position and/or movement data of the user's finger is still performed by the second controller circuit, but the forming of a movement vector may be performed by a host system, such as the host system CPU depicted in FIG. 1. If the electronic assembly is in mode 2, all ensuing steps 540-580 will be performed with active participation of the host system CPU.

At step 540 and in mode 1, the elements of the movement vector are compared with a movement threshold value to check if a movement threshold criterion v<=vt (vt being the threshold value) is fulfilled. As mentioned earlier, if the electronic assembly is in mode 1, the comparison between the elements of the movement vector and the movement threshold value will be performed without the participation of the host system. This may be done by a processing circuit, such as the first processing circuit PC1 in FIG. 1 located in the first controller circuit. In effect, the first controller circuit will receive the user's finger movement values from the second controller circuit and in the processing circuit convert them into a movement vector plus compare it with the movement threshold value vt.

If in mode 2, the host system will perform the same calculation and comparison instead.

If at step 540 and in mode I the processing circuit in the first controller circuit detects that the movement threshold criterion \<=vt is fulfilled, the processing circuit checks at step 550 from the data received from the second controller circuit whether the user's finger is on the touch-sensitive surface.

If yes, the first controller circuit instructs at step 580 the fingerprint scanner, with which it is in electrical contact, to perform a fingerprint scan of the user's finger at the location on the touch-sensitive area where the movement threshold criterion is fulfilled.

At the next step 590, the first controller circuit instructs the fingerprint scanner to be switched off until next time when a fingerprint scan is necessary for user identification.

On the other hand, if in mode I and at step 550 it is detected that the user's finger is still not on the touch-sensitive surface, the processing circuit may from the data received from the second controller circuit on the movement of the user's finger over the touch-sensitive surface at step 560 predict the position of the user's finger where the movement threshold criterion will be fulfilled and where the user's finger will be on the touch-sensitive surface.

At step 570, the first controller circuit 570 may then activate the fingerprint sensor at the position corresponding to the predicted position of the user's finger on the touch-sensitive surface where the movement threshold criterion will be fulfilled.

Otherwise, if in mode 2, the host system will perform the comparison between the elements of the movement vector formed at step 520 and the movement threshold value at step 540.

At step 550) and in mode 2, the host system will check from the data received from the second controller circuit whether the user's finger is on the touch-sensitive surface or not.

If yes, the host system will at step 580 instruct the first controller circuit to send a signal to the fingerprint scanner to perform a fingerprint scan of the user's finger at a position on the fingerprint scanner corresponding to the position of the user's finger on the touch-sensitive surface where the movement threshold criterion has been fulfilled. Thereafter, at step 590 it will instruct the first controller circuit to switch of the fingerprint scanner.

If however at step 550 and in mode 2, the host system detects that the user's finger is not on the touch-sensitive surface it will at step 560 from the data on the movement of the user's finger above the touch-sensitive surface predict the possible later position of the user's finger on the touch-sensitive surface. Then, at step 570, the host system may instruct the first controller circuit to activate the fingerprint scanner at the predicted position corresponding to the predicted position on the touch-sensitive surface.

It should be mentioned that in addition to step 550 when in mode 2, the method according to the present solution may also include a further comparison between the current movement of the user's finger and the position of one or more interactive areas on the touch-sensitive surface associated a software application currently run by the host system. If the host system through calculation of the current movement of the user's finger on or above the touch-sensitive surface predicts that the user's finger will reach or land on one of these interactive areas, it may issue a command to the first controller circuit to activate the fingerprint sensor corresponding to this interactive area in preparation for a fingerprint scan. When the host system has finally detected that the threshold criterion v<=vt over the interactive area has been met, it may then issue a command to the first controller circuit to instruct the fingerprint scanner to scan the user's finger at the position on the fingerprint scanner corresponding to the position of the user's finger on the interactive area.

It should be mentioned that the method steps illustrated in FIG. 5 may be implemented by a computer program product comprising computer program code, when the computer program code is executed by the host system of the electronic assembly mentioned earlier.

Also, the steps of the method according to FIG. 5 may be implemented by computer program product comprising computer program code stored on a computer readable medium.

While these example embodiments attempt to clarify the main idea behind the present solution it will be apparent to those skilled in the art who have read the above description that other possible embodiment may be constructed without departing from the scope of the accompanying claims.

1-26. (canceled)

27. An electronic assembly for detecting a user's fingerprints, comprising:
a touch-sensitive surface configured to register user touch;
a fingerprint sensor for detecting user's fingerprints on at least a part of the touch-sensitive surface;
a first controller circuit configured to activate the fingerprint sensor and receive fingerprint information from the fingerprint sensor;
a second controller circuit configured to detect a position and/or movement of a user's finger on or above the touch-sensitive surface, in response to signals from the touch-sensitive surface;
a host system connected to the first and second controller circuits, the host system comprising circuitry for processing information received from the first and second controller circuits,
wherein the first controller circuit is further configured to receive information from the second controller circuit related to the current position and/or movement of the user's finger on or above the touch-sensitive surface and activate a portion of the fingerprint sensor on which to perform fingerprint reading.

28. The electronic assembly of claim 27, wherein the first controller circuit is further configured to instruct the fingerprint sensor to perform a fingerprint reading at the portion of the fingerprint sensor corresponding to the position of the user's finger on the touch-sensitive surface received from the second controller circuit.

29. The electronic assembly of claim 27, further comprising a processing circuit in one of the first controller circuit and the second controller circuit, wherein the processing circuit is configured to compute data related to the movement of the user's finger on or above the touch-sensitive surface from signals received from the touch-sensitive surface, the processing circuit being further configured to compare the data related to the movement of the user's finger with a movement threshold value.

30. The electronic assembly of claim 29, wherein the first controller circuit is configured to activate the fingerprint sensor at a position where the data related to the movement of the user's finger is equal to or below the movement threshold value.

31. The electronic assembly of claim 29, wherein the first controller circuit is further configured to instruct the fingerprint sensor to perform a fingerprint reading at the position on the touch-sensitive surface where the data related to the movement of the user's finger is equal to or below the movement threshold value.

32. The electronic assembly of claim 29, wherein the data related to the movement of the user's finger on or over the touch-sensitive surface calculated by the processing circuit is generated in the form of a movement vector.

33. The electronic assembly of claim 29, wherein the data related to the movement of the user's finger comprises one of speed, acceleration, deceleration or direction of movement of the user's finger on or above the touch-sensitive surface.

34. The electronic assembly of claim 30, wherein the movement threshold value comprises one of speed, acceleration, deceleration or direction of movement of the user's finger on or above the touch-sensitive surface.

35. The electronic assembly of claim 27, wherein the first and second controller circuits in a first mode of operation are configured to communicate with each other independently of the host system.

36. The electronic assembly of claim 27, wherein the first and second controller circuits in a second mode of operation are configured to communicate with the host system, the host system in the second mode of operation being configured to transmit data associated with the position and/or movement of the user's finger over one or more interactive areas on the touch-sensitive surface to the processing circuit, the one or more interactive areas being associated with expected user input via touch.

37. The electronic assembly of claim 36, wherein the position of one or more interactive areas on the touch-sensitive surface is dependent on the particular software application run by the host system.

38. The electronic assembly of claim 36, wherein the processing circuit is further configured to compare the data received from the host system with a movement threshold value and the position of one or more interactive areas on the touch sensitive surface and to instruct the first controller circuit to activate the fingerprint sensor when the movement of the user's finger is below the movement threshold value and the user's finger is within the one or more interactive areas.

39. The electronic assembly of claim 38, wherein the processing circuit is configured to instruct the first controller circuit to let the fingerprint scanner perform a fingerprint scan when the movement of the user's finger is below the movement threshold value and the position of the user's finger is within the one or more interactive areas and on the touch-sensitive surface.

40. The electronic assembly of claim 27, wherein the first controller circuit is in communication with a secure area of the host system and wherein the first controller circuit is configured to compare the fingerprint scanned by the fingerprint scanner with one or more reference user fingerprints in the secure area of the host system.

41. The electronic assembly of claim 27, wherein the host system is configured to be activated once the comparison between the fingerprint scanned by fingerprint scanner and one or more reference user fingerprints stored in the host system is positive.

42. The electronic assembly of claim 40, wherein the one or more reference user fingerprints are stored in an internal memory of the secure area.

43. The electronic assembly of claim 27, wherein the fingerprint sensor is located behind the touch-sensitive surface and wherein the size of the fingerprint sensor is such that it covers at least a portion of the touch-sensitive surface.

44. The electronic assembly of claim 27, wherein the fingerprint sensor is located behind the touch-sensitive surface and wherein the size of the fingerprint sensor is such that it covers the entire touch-sensitive surface.

45. The electronic assembly of claim 27, further comprising a memory, the memory being configured to store information related to the movement of the user's finger on or over the touch-sensitive surface and/or fingerprints registered by the fingerprint sensor.

46. The electronic assembly of claim 27, wherein the touch-sensitive surface is a touchscreen.

47. An electronic apparatus comprising the electronic assembly of claim 27, further comprising a display for displaying a Graphical User Interface aimed at user interaction with the electronic device, wherein the display is located behind the touch-sensitive surface of the electronic assembly and the fingerprint sensor of the electronic device.

48. The electronic apparatus of claim 47, wherein the electronic apparatus is a communication apparatus.

49. The electronic apparatus of claim 48, where the communication apparatus is any one of a wireless communication apparatus for a cellular communication system, a tablet computer, a laptop computer, and a touch-screen terminal.

50. A method for detecting user's fingerprints on a touch-sensitive surface, comprising:
receiving information related to the current position and/or movement of the user's finger on or above the touch-sensitive surface in a second controller circuit;
activating a portion of a fingerprint sensor on which to perform fingerprint reading by a first controller circuit; and
performing fingerprint reading on the portion of the fingerprint sensor corresponding to the position of the user's finger and/or where the movement of the user's finger is below a movement threshold value on the touch-sensitive surface,
wherein activation of the fingerprint sensor and fingerprint reading is done independently of a host system communicating with the first and second controller circuits.

51. A non-transitory computer-readable medium comprising, stored thereupon, a program product comprising computer program code executable by processing circuitry of an electronic assembly, the program code being configured to cause the electronic assembly to carry out a method according to claim 50.
